(19) United States
(12) Patent Application Publication
(10) Pub. No.: US 2026/0069980 A1
(43) Pub. Date: Mar. 12, 2026

(54) ONE OR MORE NON-TRANSITORY COMPUTER-READABLE MEDIA, INFORMATION PROCESSING SYSTEM, AND INFORMATION PROCESSING METHOD

(71) Applicant: NINTENDO CO., LTD., Kyoto (JP)

(72) Inventors: Shuntaro YAMAGUCHI, Kyoto (JP); Shintaro JIKUMARU, Kyoto (JP)

(21) Appl. No.: 19/313,395

(22) Filed: Aug. 28, 2025

(30) Foreign Application Priority Data
Sep. 12, 2024 (JP) 2024-157911

(51) Int. Cl. A63F 13/56; A63F 13/497; A63F 13/69; A63F 13/79; A63F 13/803

(52) U.S. Cl. CPC A63F 13/56; A63F 13/497; A63F 13/69; A63F 13/79; A63F 13/803

(57) ABSTRACT

In an example of a game according to an exemplary embodiment, movement control of a player object is performed on a field, movement control of another object is performed, in accordance with a moving distance of the player object or a lapse of time, history information including at least either of a velocity and a position of the player object in chronological order is stored, in accordance with a first instruction based on an operation input, the movement control of the other object is continued, the movement control of the player object is suspended, and based on the history information, rewind control for returning the player object to a position in the past in reverse order to the chronological order in which the history information is stored is performed.

### CROSS REFERENCE TO RELATED APPLICATION

This application claims priority to Japanese Patent Application No. 2024-157911 filed on Sep. 12, 2024, the entire contents of which are incorporated herein by reference.

### FIELD

An exemplary embodiment relates to one or more non-transitory computer-readable media, an information processing system, and an information processing method that enable the execution of a racing game.

### BACKGROUND AND SUMMARY

Conventionally, there is a system that performs a racing game where a player object is moved.

In the above conventional game, there is a function in which, if the player object departs from a course, the player object is automatically returned to the course. However, this is not a function in which the player object freely returns to the previous position.

An exemplary embodiment discloses a game program, an information processing system, and an information processing method having a function capable of returning a player object that moves on a field to a position in the past.

The exemplary embodiment employs the following configurations.

### (First Configuration)

A first configuration is one or more non-transitory computer-readable media having stored therein instructions that, when executed, cause one or more processors of an information processing apparatus to execute game processing. The game processing includes in a first scene, executing a racing game by performing movement control of a player object based on an operation input on a field in a virtual space. The game processing also includes in a second scene, performing the movement control of the player object based on an operation input on the field, performing movement control of another object on the field, in accordance with a moving distance of the player object or a lapse of time, storing history information including at least either of a velocity and a position of the player object in chronological order, and in accordance with a first instruction based on an operation input, continuing the movement control of the other object, suspending the movement control of the player object, and based on the history information, performing rewind control for returning the player object to a position in the past in reverse order to the chronological order in which the history information is stored.

Based on the above, on a field where a racing game is performed, by a technique not for returning the entirety of a scene to the previous scene, but capable of returning only a player object, it is possible to return the player object in accordance with an instruction.

### (Second Configuration)

According to a second configuration, in the above first configuration, the game processing may further include in the second scene, after the rewind control is performed, resuming the movement control of the player object, and resuming the storage of the history information in chronological order from continuation of the history information up to a point to which the rewind is performed.

Based on the above, even after rewind is performed, history information is stored from continuation, whereby it is possible to further perform rewind after that.

### (Third Configuration)

According to a third configuration, in the above second configuration, the game processing may further include in the second scene, if the player object comes into contact with the other object when the rewind control is being performed, ending the rewind control.

Based on the above, if the player object comes into contact with another object during rewind control, the rewind control is ended, whereby it is possible to prevent an unintended behavior due to a forced movement. Also after the rewind control is ended, it is possible to further perform the rewind control.

### (Fourth Configuration)

According to a fourth configuration, in any of the above first to third configurations, the game processing may further include in the second scene, while the first instruction is continuing to be given, continuing the rewind control.

Based on the above, it is possible to continue rewind control by a continuous first instruction.

### (Fifth Configuration)

According to a fifth configuration, in any of the above first to fourth configurations, the history information may include the velocity of the player object. The game processing may further include after the rewind control is performed, based on the velocity stored at a point to which the rewind is performed in the history information, setting the velocity of the player object and resuming the movement control of the player object.

Based on the above, after rewind control, it is possible to smoothly resume movement control of the player object.

### (Sixth Configuration)

According to a sixth configuration, in the above fifth configuration, the game processing may further include after the rewind control is performed, and when the movement control of the player object is resumed, if a forward movement instruction based on an operation input is being given, setting a moving velocity of the player object based on the velocity stored at a point to which the rewind is performed, and if the forward movement instruction is not being given, stopping the player object.

Based on the above, after the rewind control, it is possible to smoothly resume the movement control of the player object.

### (Seventh Configuration)

According to a seventh configuration, in any of the above first to sixth configurations, the history information may further include an orientation of the player object. The game processing may further include in the second scene, after the rewind control is performed, based on the orientation stored at a point to which the rewind is performed in the history information, setting the orientation of the player object, and if a direction change instruction based on an operation input is further given, further changing the orientation of the player object and resuming the movement control of the player object.

Based on the above, after rewind control, it is possible to smoothly resume movement control of the player object.

### (Eighth Configuration)

According to an eighth configuration, in any of the above first to seventh configurations, the game processing may further include: in the first scene and the second scene, if the player object satisfies a predetermined condition, causing the player object to transition to a state where the player object possesses an item for which a predetermined effect is set, and if the player object is in the state where the player object possesses the item, in accordance with a second instruction based on an operation input, producing the effect set for the item and causing the player object to transition to a state where the player object does not possess the item; and in the second scene, further storing information regarding the item possessed by the player object in chronological order as the history information, and in the rewind control, further, based on the history information, returning the item possessed by the player object to a state in the past in reverse order to the chronological order in which the history information is stored.

Based on the above, it is possible to return an item possession state of the player object.

### (Ninth Configuration)

According to a ninth configuration, in the above eighth configuration, the game processing may further include in the second scene, if the first instruction is given while the effect of the item is being produced, cancelling the effect of the item and performing the rewind control.

Based on the above, it is possible to cancel the effect of an item and perform rewind control. For example, it is possible to perform rewind control without greatly changing the situation of a game.

### (Tenth Configuration)

According to a tenth configuration, in any of the above first to ninth configurations, the second scene may be a scene where the movement control of the player object is performed based on an operation input without performing a race on the field.

Based on the above, it is possible to perform rewind control in a scene where a race is not performed.

### (Eleventh Configuration)

According to an eleventh configuration, in any of the above first to tenth configurations, the game processing may further include: in the first scene, executing the racing game on a course set on the field, and if the player object departs from the course during the racing game, placing the player object in the course again and resuming the movement control of the player object; and in the second scene, performing the movement control of the player object on the field where a course is not set.

Based on the above, in a case where movement control of the player object is performed in a second scene where a course is not set, it is possible to return the player object by rewind control.

### (Twelfth Configuration)

According to a twelfth configuration, in any of the above first to eleventh configurations, the first scene may be a scene where a racing game where an opponent object as an opponent in a race includes an opponent player object controlled in accordance with an operation of another player based on communication is performed, and the second scene may be a scene where a racing game where the opponent object does not include the opponent player object is performed.

Based on the above, it is possible to return the player object by rewind control in a second scene where an opponent player object is not present.

### (Thirteenth Configuration)

According to a thirteenth configuration, in any of the above first to twelfth configurations, the second scene may include a scene during a racing game in the first scene.

Based on the above, during the racing game, it is possible to return the player object by rewind control.

Another configuration may be an information processing system, an information processing apparatus, or an information processing method that executes the above game program.

According to the exemplary embodiment, on a field where a racing game is performed, it is possible to not return the entirety of a scene to the previous scene, but return only a player object.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of a road AR1 set in a base area A1;

FIG. 5 is an example non-limiting diagram showing an example of a game image displayed on a display device of the main body apparatus 2 during a first type of game;

FIG. 6 is an example non-limiting diagram showing an example of a game image displayed when a player object 50 hits an item acquisition object 75 and acquires an item;

FIG. 7 is an example non-limiting diagram showing an example of history information recorded during the first or second type of game;

FIG. 8 is an example non-limiting diagram showing an example of the history information after a game is resumed in a case where a rewind instruction ends when the player object 50 returns to the state of No. 3 shown in FIG. 7;

FIG. 9 is an example non-limiting diagram showing an example of a game image displayed when a rewind process is performed during the first type of game;

FIG. 10 is an example non-limiting diagram showing an example of a game image displayed when the rewind process is performed during the second type of game, and an example of the rewind process on an item possession state;

FIG. 11 is an example non-limiting diagram showing examples of various pieces of data stored in the game system 1;

FIG. 12 is an example non-limiting flow chart showing an example of a game selection process;

FIG. 13 is an example non-limiting flow chart showing an example of first game processing regarding the first type of game;

FIG. 14 is an example non-limiting flow chart showing an example of a player object control process in step S13;

FIG. 15 is an example non-limiting flow chart showing an example of a rewind process in step S29;

FIG. 16 is an example non-limiting flow chart showing an example of a rewind end process in step S35; and

FIG. 17 is an example non-limiting flow chart showing an example of second game processing regarding the second type of game.

### DETAILED DESCRIPTION OF NON-LIMITING EXAMPLE EMBODIMENTS

### (Game System Configuration)

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons (an A-button, a B-button, an X-button, a Y-button, an L-button, and an R-button), and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

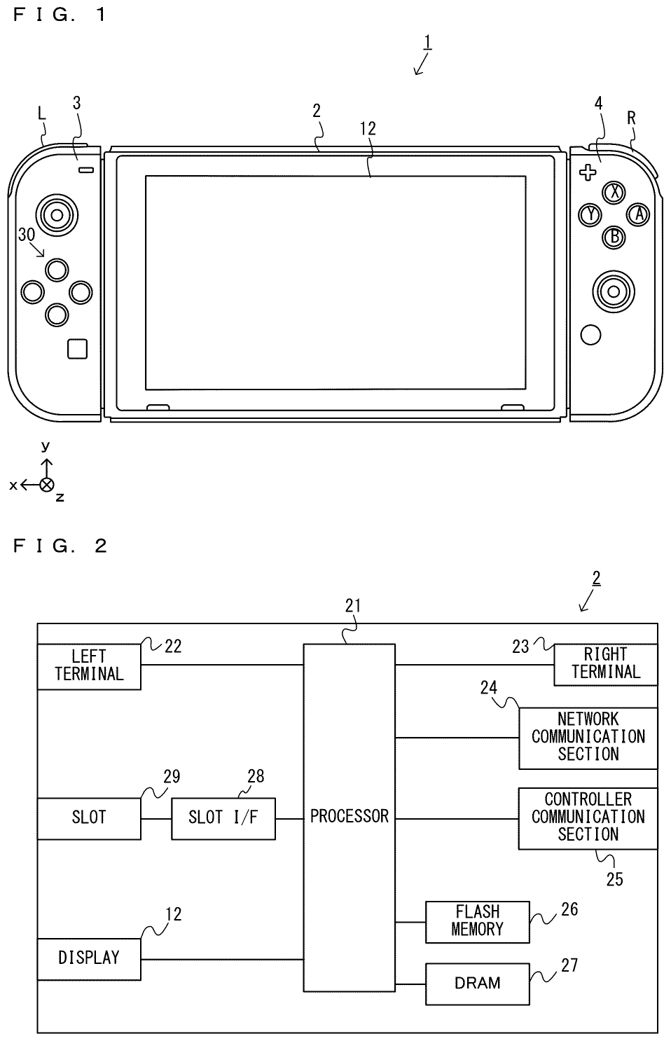

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### (Overview of Game)

Next, an overview of a game executed by the game system 1 is described. The game according to the exemplary embodiment is a game where a player object operated by a first player is moved in a virtual space (a game space).

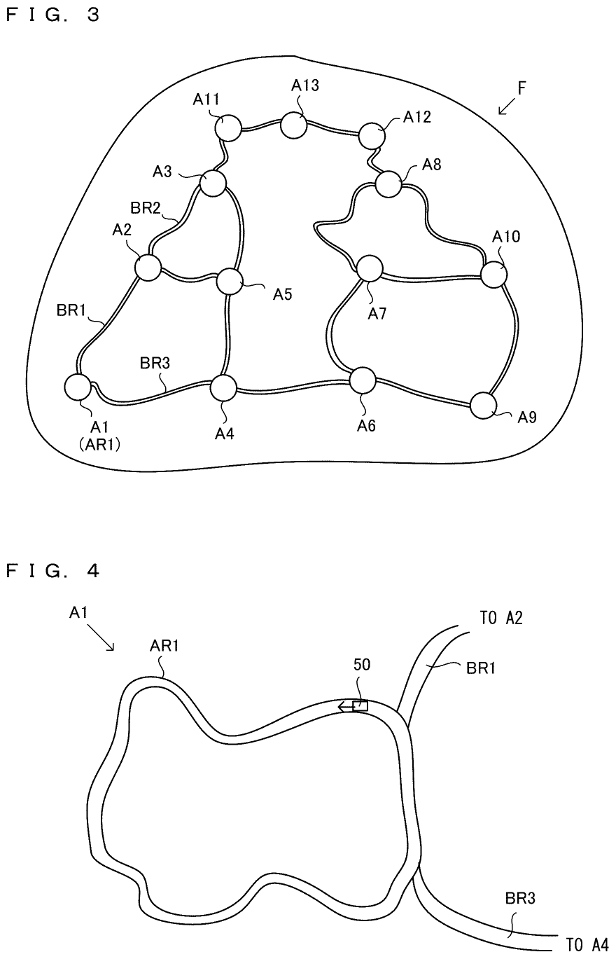

First, a description is given of a field in the virtual space where the game according to the exemplary embodiment is performed. FIG. 3 is a diagram showing an example of the entirety of a field F in the virtual space.

In the exemplary embodiment, a broad field F is set in the virtual space (the game space), and the first player can perform a racing game on various courses set on the field. As shown in FIG. 3, a plurality of base areas A are set on the field F in the virtual space. In each base area A, a road where the player object is assumed to be caused to run is set. For example, a base area A1 is an area indicating a single city, and a road AR1 where the player object is assumed to be caused to run is set in the base area A1.

A plurality of base areas are linked together by a road where the player object is assumed to be caused to run. For example, the base area A1 and a base area A2 are linked together by a road BR1. The base area A2 and a base area A4 are linked together by a road BR3.

Hereinafter, a road AR provided in a base and a road BR provided between bases are occasionally referred to simply as a “road R”. The road R particularly refers to an area set by assuming the running of the player object in the field set in the virtual space. On the field, areas (e.g., a grassland, a sandy place, a water surface, and the like) and the like other than the road R are also set.

FIG. 4 is a diagram showing an example of the road AR1 set in the base area A1.

As shown in FIG. 4, in the base area A1, the road AR1 is provided. In the road AR1, a gate that can be a starting point and a goal point is provided. The road AR1 is connected to the roads BR1 and BR3. The road BR1 is joined to the base area A2. The road BR3 is joined to the base area A4.

The game according to the exemplary embodiment includes a plurality of types of games including a first type of game and a second type of game.

The first type of game is a racing game where movement control of a player object 50 operated by the first player and one or more opponent objects is performed on a course set on the field. Here, the opponent objects are objects as competitors of the player object 50. The player object 50 and the one or more opponent objects run on the course set on the field and run toward a goal point of the course. The “course” refers to the entirety of a route from a starting point to a goal point in the first type of game. Here, the “route” refers to an area where the player object 50 and the opponent objects are assumed to move in the first type of game. For example, the route is set along a road R. The route may include a road R and areas within a predetermined distance from both ends of the road R. The route does not necessarily need to be set along a road R, and may include an area other than the road R, such as a grassland, a sandy place, an area on water, an area under water, an area in the air, or the like. For example, the player object 50 may have wings and be able to move in the air in the state where the wings are spread. For example, the route may include a road R, areas within a predetermined distance from both ends of the road R, an area of a grassland, and an area in the air. In a case where the first type of game is performed, a route including a road R and an area other than the road is set, and movement control of the player object 50 is performed along the route. If the player object 50 departs from the route during the first type of game, the player object 50 is forcibly placed again on the route.

An opponent object may be operated by another player, or may be automatically controlled by the processor 21. An opponent object operated by another player is occasionally referred to as an “opponent player object”. Hereinafter, in a case where an opponent object is referred to simply as an “opponent object”, the opponent object includes both an opponent object operated by another player and an opponent object controlled by the processor 21.

The mode of the racing game performed using the player object 50 operated by the first player and an opponent player object operated by another player is referred to as a “multiplay mode”. The mode of the racing game performed using the player object 50 operated by the first player and an opponent object controlled by the processor 21 is referred to as a “single play mode”.

The multiplay mode further includes an online multiplay mode and an offline multiplay mode. In the online multiplay mode, the main body apparatus 2 is connected to the Internet, and the main body apparatus 2 communicates with another main body apparatus 2 corresponding to the other player via a server, whereby the racing game is performed between a plurality of players. In the offline multiplay mode, a single main body apparatus 2 and a plurality of controllers wirelessly communicate with each other, and each player operates a player object corresponding to the player themselves using a controller. Alternatively, in the offline multiplay mode, a plurality of main body apparatuses 2 are connected together through local communication, and each player operates a player object corresponding to the player themselves using a controller connected to a main body apparatus 2 of the player themselves. Even in the multiplay mode, the plurality of opponent objects may include an opponent object controlled by the processor 21. That is, the racing game in the multiplay mode may be performed using the player object 50 operated by the first player, an opponent player object operated by a second player, and an opponent object automatically controlled by the processor 21.

In the first type of game, a course is set on the field, and the player object 50 and the opponent objects move along the set course. The first type of game may be performed on a course where objects take multiple laps around an intra-base route set along a road AR provided in the base area A. The first type of game may be performed on a course including an inter-base route set along a road BR provided between bases.

During the first type of game, in addition to the player object 50 and the opponent objects, movement control of a non-opponent object that is not a competitor of the player object 50 is automatically performed by the processor 21. The non-opponent object is different in external appearance from the player object 50 and the opponent objects. Examples of the non-opponent object include an object that, during the first type of game, for example, moves in a forward direction of a course (a direction from a start to a goal) along a road, an object that moves in an opposite direction opposite to the forward direction of the course, and an object that moves in a direction different from the forward direction and the opposite direction. The non-opponent object may collide with the player object 50 or the opponent objects. If the player object 50 collides with the non-opponent object, the player object 50 temporarily stops or decreases its velocity. The non-opponent object is a moving object that does not participate in a race, and is an object as an obstacle to the player object 50 and the opponent objects.

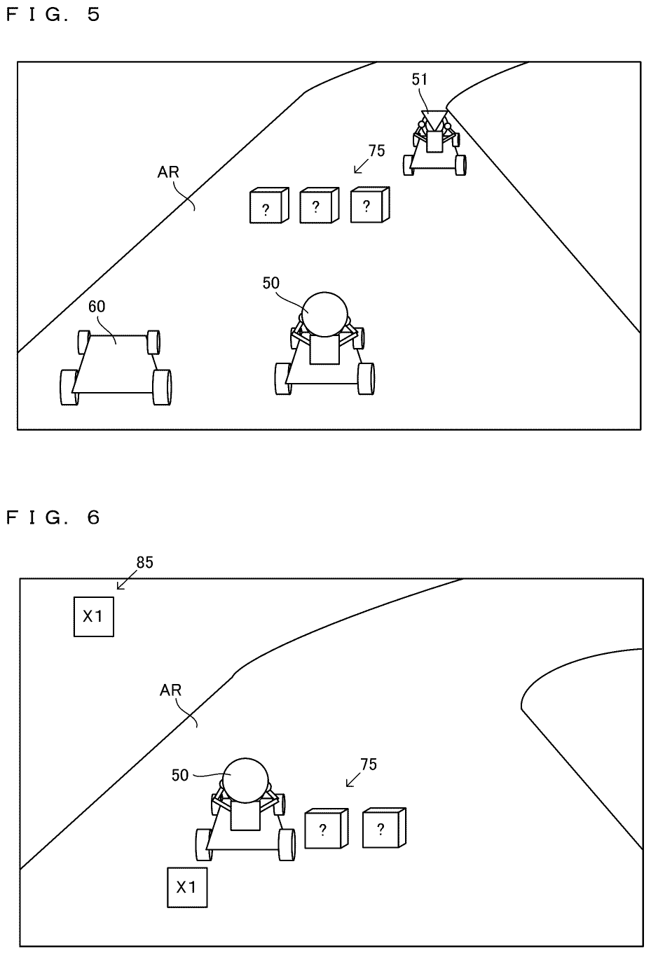

FIG. 5 is a diagram showing an example of a game image displayed on the display device of the main body apparatus 2 during the first type of game. FIG. 6 is a diagram showing an example of a game image displayed when the player object 50 hits an item acquisition object 75 and acquires an item.

As shown in FIG. 5, the player object 50 operated by the first player is located on an intra-base route (a road AR) on a vehicle object. If the first player is performing an accelerator operation (e.g., the pressing of the A-button), the player object 50 moves forward. If the first player performs a steering wheel operation (e.g., a direction input of left and right using a left stick), the moving direction of the player object 50 changes. A virtual camera that moves by following the player object 50 is placed behind the player object 50, and a game image is generated based on the virtual camera. The generated game image is displayed on a display device (the display 12 or another display device).

As shown in FIG. 5, an opponent object 51 is running on the intra-base route (the road AR) on a vehicle object. The opponent object 51 is controlled by another player or the processor 21. Although not shown in the figures, in addition to the opponent object 51, a plurality of opponent objects run on the intra-base route (the road AR). A non-opponent object 60 automatically controlled by the processor 21 is also running on the road AR. Although not shown in the figures, for example, a plurality of non-opponent objects 60 run on the road AR.

On the route, an item acquisition object 75 is also placed. The item acquisition object 75 is an object that allows the player object 50 or the opponent object 51 to acquire any item of a plurality of types of items X. Each item X produces an effect corresponding to the type of the item X when used. For example, an item X1 has the effect of temporarily increasing the velocity of an object that has used the item X1. For example, if the player object 50 uses the item X1, the velocity of the player object 50 temporarily increases. An item X2 has the effect of interfering with the running of an object different from an object that has used the item X2. For example, if the player object 50 uses the item X2, the item X2 moves in the virtual space toward a preceding opponent object. If the item X2 hits the opponent object, the opponent object temporarily stops or decreases its velocity. In addition to this, the items X include an item X3 that brings the player object 50 into an invincible state (the state where an attack of an opponent object or an obstacle placed on the course is disabled) for a predetermined period if the player object 50 uses the item X3, an item X4 that brings the player object 50 into a particular disadvantageous state for a predetermined period if an opponent object uses the item X4, and the like.

The magnitude of the effect differs in accordance with the type of the item. If the player object 50 comes into contact with the item acquisition object 75, any item of the plurality of types of items X is given to the player object 50 with a probability corresponding to the ranking of the player object 50 at that time. For example, the probability is set so that the lower the ranking is, the higher the effect of the item to be given is likely to be.

For example, as shown in FIG. 6, if the player object 50 comes into contact with the item acquisition object 75, the item X1 is given to the player object 50, and the player object 50 enters the state where the player object 50 possesses the item X1. If the player object 50 comes into contact with the item acquisition object 75, the item acquisition object 75 is erased and appears again after a predetermined period elapses.

In the state where the player object 50 possesses the item X1, an icon indicating the item X1 is displayed in an item possession area 85. In the state where the player object 50 possesses the item X1, the item X1 is displayed near the player object 50. In the state where the player object 50 possesses the item X1, if a predetermined operation input for using an item is performed, the player object 50 uses the item X1. If the player object 50 uses the item X1, the item X1 is consumed, and the velocity of the player object 50 temporarily increases. If the item X1 is consumed, the player object 50 enters the state where the player object 50 does not possess the item X1. The player object 50 can possess a plurality of items X. For example, the player object 50 can possess up to two items X. If the player object 50 possesses two items X, icons indicating the two items X are displayed in the item possession area 85. For example, the items X are used in the order of acquisition.

On the other hand, the second type of game is a game where the first player freely performs movement control of the player object 50 on the field. The second type of game is a racing game where the player object 50 and the opponent objects do not compete against each other. In the second type of game, a course is not set on the field, and the player object 50 can run on any position on the field. That is, in the second type of game, the player can move the player object 50 on a course used in the first type of game, and can freely have a practice on the same course. In the second type of game, a course is not set, and therefore, while the player object 50 is running on a road used as a course in the first type of game, and even if the player object 50 departs from the road, the player object 50 is not forcibly placed again in the road. For example, while the player object 50 is running on a road set in a high place in the virtual space, and if the player object 50 departs from the road, the player object 50 falls in the virtual space. During the second type of game, even if the player object 50 falls, the player object 50 is not forcibly placed again on the road. Then, the player object 50 can also continue to run in an area on the field other than a road. On the other hand, during the first type of game, if the player object 50 runs on the same road, departs from the road, and falls, the player object 50 is forcibly placed again on the road.

Also in the second type of game, the non-opponent object 60 as an obstacle to the player object 50 moves on the field. Also in the second type of game, the item acquisition object 75 for acquiring the above items is placed, and the player object 50 can acquire and use an item.

The second type of game can be executed by a single player using a single main body apparatus 2. The second type of game where a plurality of main body apparatuses 2 are connected to the Internet, and movement control of a player object corresponding to each of a plurality of players is performed in the same virtual space may be performed. In this case, each player moves the player object corresponding to the player themselves on the broad field without racing. For example, the first player moves a first player object corresponding to the first player themselves in the virtual space, and the second player moves a second player object corresponding to the second player themselves in the same virtual space. If the first player object and the second player object come close to each other, for example, the second player object may be displayed on a screen of the first player. Also in such a case, in the second type of game, basically, each player freely moves the player object of the player themselves on the field.

### (Rewind Function)

In the exemplary embodiment, during the first or second type of game, there is a rewind function for returning the position of the player object 50 to the previous position. First, every time the player object 50 moves forward by a predetermined distance in the virtual space, information indicating the state of the player object 50 at this point in time is recorded as history information. Then, if a rewind instruction is given by the player, a rewind process for returning the state of the player object 50 to the state in the past is performed based on the history information.

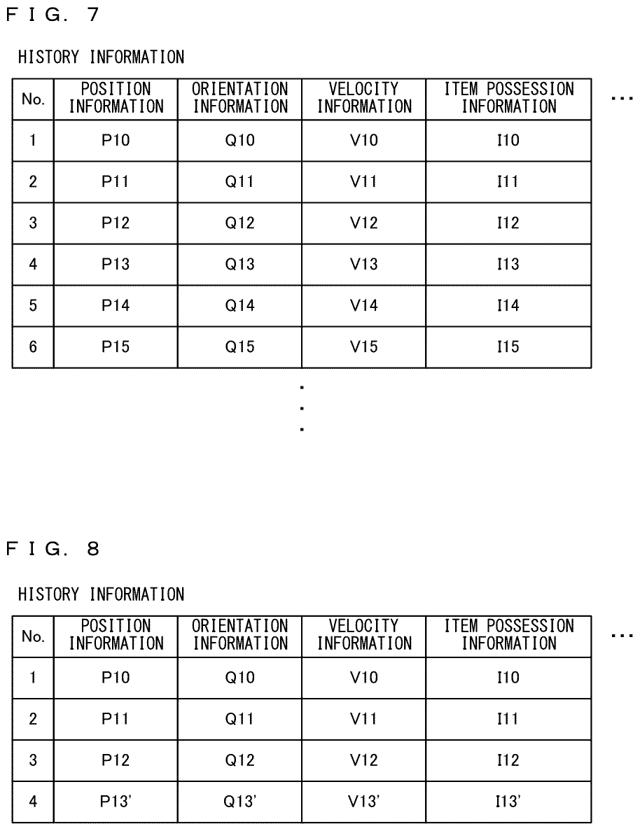

FIG. 7 is a diagram showing an example of the history information recorded during the first or second type of game. For example, every time the player object 50 moves forward by a distance of 2 m in the virtual space, the history information is recorded in chronological order in a memory (e.g., the DRAM 27 or the flash memory 26).

Specifically, as the history information, position information indicating the position of the player object 50 is stored. In association with the position information, orientation information indicating the orientation of the player object 50 and velocity information indicating the velocity of the player object 50 at this point in time are also stored. In association with the position information, item possession information indicating an item possession state at this point in time may also be stored. The item possession information includes information indicating whether or not the player object 50 possesses an item, and if the player object 50 possesses an item, information indicating the type of the item. In addition to these pieces of information, other pieces of information regarding the player object 50 (e.g., information indicating whether or not the player object 50 is in the state where the player object 50 is spreading the wings, information indicating whether or not the player object 50 is in the state where the player object 50 is on a wall surface described below, and the like) are also stored.

The recording of the history information is started at the timing when the first or second type of game is started, the timing where the game transitions to a particular scene in the first or second type of game, or the like. For example, the history information is stored in the order of No. 1 to No. 6 shown in FIG. 7. Although more pieces of history information are actually stored, FIG. 7 shows examples of No. 1 to No. 6 for convenience of description. The state indicated in No. 1 is the oldest state in the past, and the state indicated in No. 6 is the latest (or current) state of the player object 50. For example, the state indicated in No. 6 is the current state of the player object 50. That is, at the current moment, the position of the player object 50 is “P15”, the orientation of the player object 50 is “Q15”, the velocity of the player object 50 is “V15”, and the item possession state of the player object 50 is “115”. In this state, if the first player gives a rewind instruction (e.g., performs a pressing operation on the down button among the plurality of direction buttons 30) using the controller, the state of the player object 50 returns to the state in the past stored as the history information (the state indicated by any of No. 1 to No. 5).

While the rewind instruction is continuing, the rewind process regarding the player object 50 is performed. For example, if the rewind instruction continues for a first time, for example, the player object 50 returns to the state indicated in No. 4. If the rewind instruction continues for a second time longer than the first time, for example, the player object 50 returns to the state indicated in No. 2, which is a state older than that of No. 4. While the rewind instruction is continuing, the state where the position of the player object 50 is returning is displayed on the display device.

If the rewind instruction ends, the game is resumed from the place where the player object 50 is located at this point in time. If the game is resumed, the history information is stored again from this position. For example, when the player object 50 returns to the state of No. 3 shown in FIG. 7, and if the rewind instruction ends, the history information regarding No. 4 to No. 6 is deleted or discarded, and the storage of the history information is newly resumed from No. 4.

FIG. 8 is a diagram showing an example of the history information after the game is resumed in a case where the rewind instruction ends when the player object 50 returns to the state of No. 3 shown in FIG. 7. As shown in FIG. 8, the history information regarding No. 4 to No. 6 in FIG. 7 is deleted, and the history information regarding No. 4 is newly stored. The state of No. 4 in FIG. 8 is different from the state of No. 4 in FIG. 7. For example, the position of the player object 50 is “P13” in FIG. 7, and is “P13” in FIG. 8.

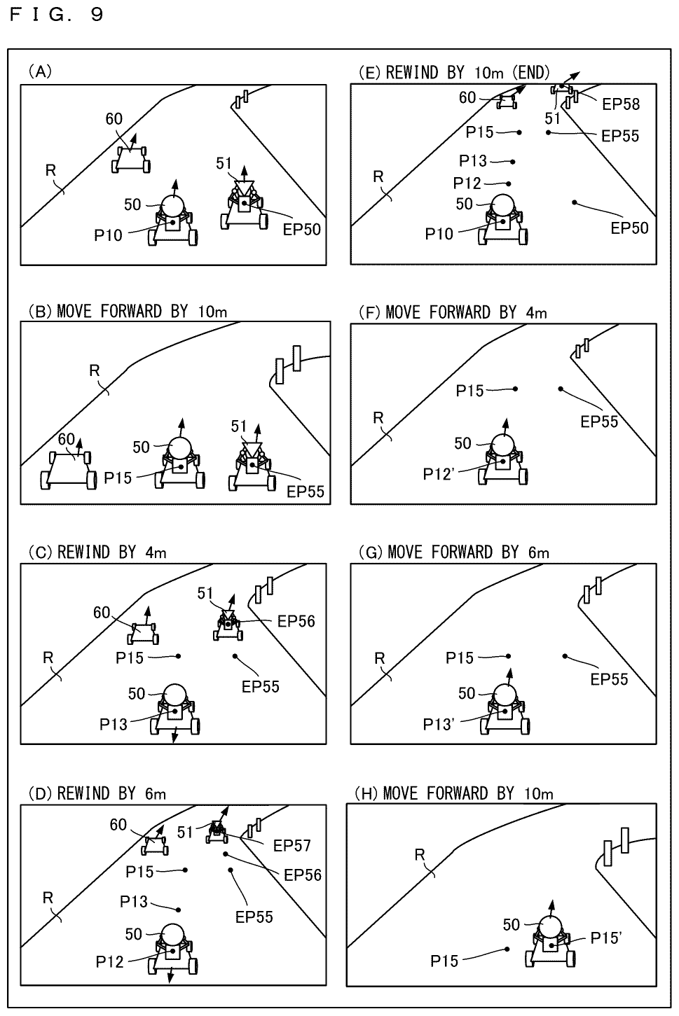

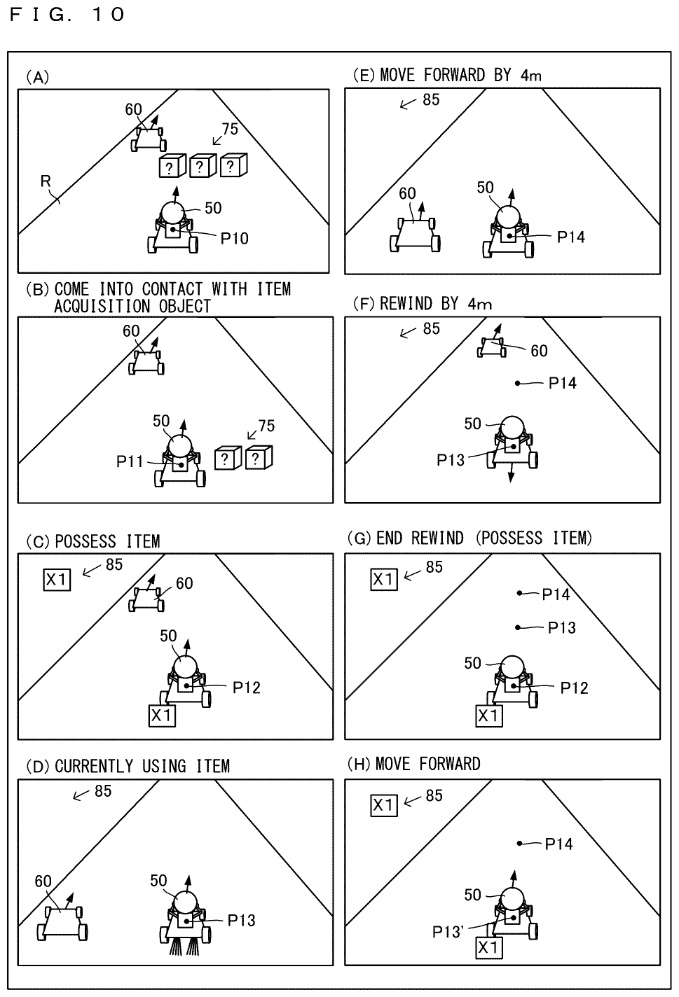

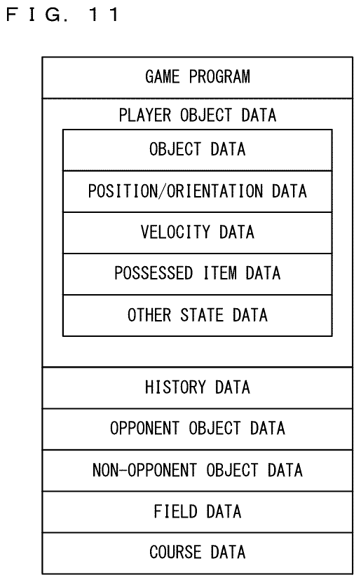

FIG. 9 is a diagram showing an example of a game image displayed when the rewind process is performed during the first type of game.

In (A) of FIG. 9. the player object 50, the opponent object 51, and the non-opponent object 60 are located on a road R. The position of the player object 50 at this point in time is “P10”, and the player object 50 is moving in an orientation (Q10) based on a steering wheel operation of the first player and at a velocity (V10) based on the accelerator operation of the first player. The position of the opponent object 51 at this point in time is “EP50”. The opponent object 51 is slightly preceding the player object 50. The non-opponent object 60 is moving forward while being located in front of the player object 50 and the opponent object 51. Arrows indicate the traveling directions of the objects. There may be a non-opponent object that runs backward relative to the player object 50.

If a predetermined time elapses from (A) of FIG. 9, as shown in (B) of FIG. 9, the player object 50 is moving forward by 10 m along the road R from the position (P10) in (A) of FIG. 9 and is located at “P15”. In (B) of FIG. 9, the opponent object 51 is also moving forward and is located at “EP55”. At this point in time, the player object 50 and the opponent object 51 are almost side by side. The non-opponent object 60 is also moving forward from the state shown in (A) of FIG. 9, but the velocity of the non-opponent object 60 is slow, and therefore, the non-opponent object 60 is almost side by side with the player object 50 and the opponent object 51.

During the period from (A) of FIG. 9 to (B) of FIG. 9, the position information, the orientation information, the velocity information, and the like regarding the player object 50 are stored as the history information in the memory. For example, as the position information regarding the player object 50, P10 to P15 are stored in chronological order. In association with the position information P10 to P15, orientation information Q10 to Q15 and velocity information V10 to V15 are also stored. Further, other states (e.g., information indicating whether or not the player object 50 is in the state where the player object 50 is spreading the wings and the like) of the player object 50 are also stored.

Here, immediately after the state shown in (B) of FIG. 9, a rewind instruction is started by the first player. (C) of FIG. 9 is a game image displayed when a first time elapses after the rewind instruction is started, and is a game image displayed when the player object 50 is rewound by 4 m from (B) of FIG. 9. As shown in (C) of FIG. 9, the player object 50 returns to the position P13 closer to a starting point than P15. The orientation of the player object 50 at this point in time also returns to the orientation Q13 stored in association with the position P13. On the other hand, the opponent object 51 is moving further forward than the position EP55 in (B) of FIG. 9 and is located at “EP56”. The non-opponent object 60 is also moving further forward than the position in (B) of FIG. 9.

While the effect of an item is being produced, and if a rewind instruction is started, the effect of the item is cancelled, and the rewind process is started. For example, when the velocity of the player object 50 is temporarily increasing by the player object 50 using the item X1, and if a rewind instruction is started, the increase in the velocity by the item X1 is cancelled, and the rewind process is started. When the player object 50 is temporarily in the invincible state by using the item X3, and if a rewind instruction is started, the invincible state is cancelled, and the rewind process is started. When the player object 50 is temporarily in the disadvantageous state by an opponent object using the item X4, and if a rewind instruction is started, the disadvantageous state is cancelled, and the rewind process is started.

If the rewind instruction further continues to be given from the state shown in (C) of FIG. 9, a game image shown in (D) of FIG. 9 is displayed. (D) of FIG. 9 is a game image displayed when a second time longer than the first time elapses after the rewind instruction is started, and is a game image displayed when the player object 50 is rewound by 6 m from (B) of FIG. 9. As shown in (D) of FIG. 9, the player object 50 returns to the position P12 closer to the starting point than P13. On the other hand, the opponent object 51 is moving further forward than the position EP56 in (C) of FIG. 9 and is located at “EP57”. The non-opponent object 60 is also moving further forward than the position in (C) of FIG. 9.

The rewind instruction further continues to be given, and the rewind instruction ends at the point in time when a game image shown in (E) of FIG. 9 is displayed. (E) of FIG. 9 is a game image displayed when a third time longer than the second time elapses after the rewind instruction is started, and is a game image displayed when the player object 50 is rewound by 10 m from (B) of FIG. 9. As shown in (E) of FIG. 9, the player object 50 returns to the position P10 closer to the starting point than P12. On the other hand, the opponent object 51 is moving further forward than the position EP57 in (D) of FIG. 9 and is located at “EP58”. The non-opponent object 60 is also moving further forward than the position in (D) of FIG. 9.

If the rewind instruction ends in the state shown in (E) of FIG. 9, the rewind process regarding the player object 50 ends, and the game is resumed from the state where the player object 50 is located at “P10”. If the accelerator operation is being performed at the point in time when the rewind process ends, the velocity of the player object 50 is set based on the velocity V10 stored as the history information in association with the position P10. Specifically, if the velocity V10 stored as the history information is greater than or equal to a predetermined velocity, the velocity of the player object 50 at the point in time when the rewind process ends is set to “V10”. That is, the stored “V10” is imparted as the initial velocity of the player object 50 when the game is resumed. If the velocity V10 stored as the history information is less than the predetermined velocity, the velocity of the player object 50 at the point in time when the rewind process ends is set to a certain velocity. On the other hand, if the accelerator operation is not being performed at the point in time when the rewind process ends, the velocity of the player object 50 is set to “0”. That is, if the accelerator operation is not being performed at the point in time when the rewind process ends, the game is resumed in the state where the player object 50 is stopped at the position P10.

The orientation of the player object 50 is set based on the orientation Q10 stored as the history information in association with the position P10. Specifically, if a predetermined orientation change operation (e.g., an operation of tilting a stick to left and right while pressing the R-button) is not being performed at the point in time when the rewind process ends, the orientation of the player object 50 at the point in time when the rewind process ends is set to the orientation Q10 stored as the history information. On the other hand, if the predetermined orientation change operation is being performed at the point in time when the rewind process ends, the orientation of the player object 50 at the point in time when the rewind process ends is set to an orientation obtained by correcting Q10 stored as the history information in accordance with the orientation change operation. For example, if the R-button is pressed and the stick is tilted in the left direction at the point in time when the rewind process ends, the orientation of the player object 50 at the point in time when the rewind process ends is set to an orientation obtained by correcting the orientation Q10 stored as the history information to the left direction.

In the example shown in FIG. 9, the accelerator operation is being performed and the orientation change operation is not being performed at the point in time in (E) of FIG. 9. Thus, the velocity of the player object 50 at the point in time when the rewind process ends is set to “V10”, and the orientation of the player object 50 at the point in time when the rewind process ends is set to “Q10”.

If a predetermined time elapses after the rewind process ends, as shown in (F) of FIG. 9, the player object 50 moves forward by 4 m along the road R from the position P10 in (E) of FIG. 9 and is located at “P12”. If the rewind process ends and the game is resumed, the player object 50 does not necessarily pass through a position through which the player object 50 has passed in the past. The state (the position, the orientation, the velocity, and the like) of the player object 50 at each point in time after the game is resumed is set in accordance with an operation performed by the first player after the game is resumed. On the other hand, the opponent object 51 is moving further forward than the position EP58 in (E) of FIG. 9, is going out of the field of view of the virtual camera, and is not displayed on the screen. The non-opponent object 60 is also moving further forward than the position shown in (E) of FIG. 9 and is not displayed.

If time elapses from (F) of FIG. 9, as shown in (G) of FIG. 9, the player object 50 is moving forward by 6 m along the road R from the position P10 in (E) of FIG. 9 and is located at “P13′”. Further, if time elapses from (G) of FIG. 9, as shown in (H) of FIG. 9, the player object 50 is moving forward by 10 m along the road R from the position P10 in (E) of FIG. 9 and is located at “P15”.

During the rewind process in (C) to (E) of FIG. 9, if the player object 50 collides with another object, the rewind process is forcibly ended even if the rewind instruction is continuing at this point in time. As described above, during the rewind process, the player object 50 gradually returns to the state in the past (e.g., runs backward relative to a normal traveling direction set on the course), whereas another object moves forward. Thus, the other object may move onto a path that the player object 50 has followed in the past, and during the rewind process, the player object 50 and the other object may collide with each other. If the other object is present at a position to which the player object 50 returns, the player object 50 is present within the other object, and a failure may occur. Thus, in the exemplary embodiment, during the rewind process, if the player object 50 collides with another object, the rewind process is forcibly ended at this point in time. Immediately before the player object 50 collides with another object, the rewind process may be forcibly ended. Even if the rewind process forcibly ends, an instruction to perform rewind can be given again. Thus, after another object leaves, the player object 50 can be further rewound to a position in the past.

As described above, in the exemplary embodiment, while movement control of the player object 50 is being performed, every time the player object 50 moves forward by a predetermined distance, the state of the player object 50 is stored as the history information. When the movement control of the player object 50 is being performed, and if a rewind instruction is given, the movement control of the player object 50 is suspended, and the rewind process for returning the state of the player object 50 to the state in the past is performed based on the history information. Even while the rewind process is performed, movement control of objects in the virtual space other than the player object 50 (movable objects such as the opponent object 51, the non-opponent object 60, and the like) continues to be performed.

Consequently, it is possible to rewind only the player object 50 to the state in the past without suspending the movement control of the objects other than the player object 50. Thus, for example, the player can return to a position through which the player object 50 has passed through in the virtual space, cause the player object 50 to run on this position again, and start over. Thus, it is also possible to utilize this for the practice of a course. For example, when the player object 50 is moving in the virtual space, and even if the player object 50 passes a place or an object found by the player, the player can view the place or the object that the player object 50 has passed by returning the position of the player object 50 by the rewind process.

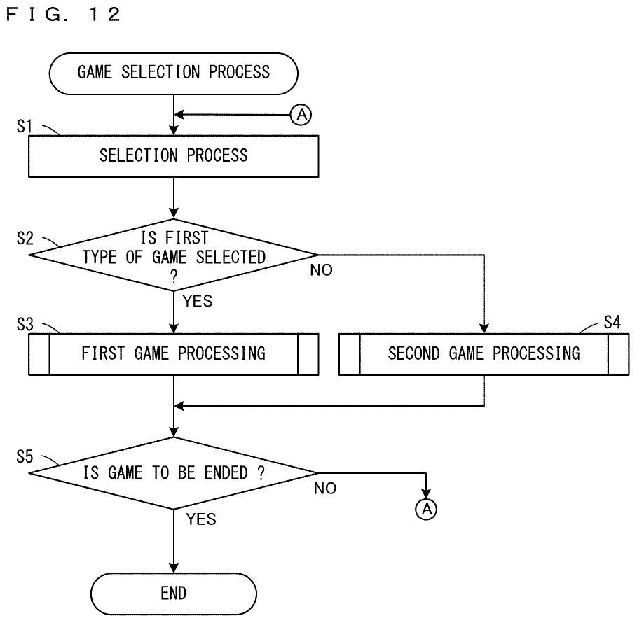

Next, the rewind of the item possession state is described. FIG. 10 is a diagram showing an example of a game image displayed when the rewind process is performed during the second type of game, and an example of the rewind process on the item possession state.

As shown in (A) of FIG. 10, the player object 50 is freely running on the field. For example, the player object 50 runs on a road R set on the field. The player object 50 can run on any position on the field. As shown in (A) of FIG. 10, the player object 50 is located at “P10”. In front of the player object 50, the non-opponent object 60 automatically controlled by the processor 21 is present and is moving forward. In front of the player object 50, the item acquisition object 75 is also displayed.

If a predetermined time elapses from (A) of FIG. 10, as shown in (B) of FIG. 10, the player object 50 is located at “P11” and comes into contact with the item acquisition object 75. In accordance with the contact, the item X1 is given to the player object 50, and the player object 50 enters the state where the player object 50 possesses the item X1 ((C) of FIG. 10). At this point in time, the player object 50 is located at “P12”.

Here, if an instruction to use an item is given by the player immediately after (C) of FIG. 10, the player object 50 uses the item X1 possessed by the player object 50. If the item X1 is used, an effect corresponding to the item X1 is produced, and the player object 50 enters the state where the player object 50 does not possess the item X1. Through the use of the item X1, the velocity of the player object 50 temporarily increases.

In (D) of FIG. 10, the velocity of the player object 50 temporarily increases through the use of the item X1. Here, the player object 50 is moving forward from P12 and is located at “P13”. The player object 50 is catching up with the non-opponent object 60. Immediately after (D) of FIG. 10, the effect of the item X1 ends.

After the effect of the item X1 ends, the player object 50 moves forward by, for example, 4 m from P13 and is located at P14 ((E) of FIG. 10). The non-opponent object 60 is also side by side with the player object 50.

Here, immediately after the state shown in (E) of FIG. 10, a rewind instruction is started by the player. While the rewind instruction is continuing, the rewind process regarding the player object 50 is performed. If a predetermined time elapses after the rewind instruction is started, as shown in (F) of FIG. 10, the player object 50 enters the state where the player object 50 is rewound by 4 m from (E) of FIG. 10, and the position of the player object 50 returns to “P13”. Even while this rewind process is performed, the non-opponent object 60 moves forward.

If the rewind instruction further continues, as shown in (G) of FIG. 10, the position of the player object 50 returns to “P12”. The item possession state of the player object 50 also returns to the state where the player object 50 is located at P12. Specifically, the item possession state returns to the state where the player object 50 possesses the item X1. The non-opponent object 60 is moving further forward and is going out of the field of view of the virtual camera in (G) of FIG. 10. Then, at the point in time in (G) of FIG. 10, the rewind instruction ends, and the rewind process ends. Consequently, in the state where the player object 50 is located at “P12” and possesses the item X1, the game is resumed.

The player object 50 resumes the movement from the position “P12”, moves forward by a predetermined distance, and is located at P13′ ((H) of FIG. 10). P13′ is a position different from P13 in (D) of FIG. 10. After the game is resumed, an instruction to use an item is not given. Thus, at this position, the player object 50 does not use the item X1, and is in the state where the player object 50 possesses the item X1.

As described above, in addition to the position information, the orientation information, and the velocity information regarding the player object 50, the item possession state also returns to the state in the past by the rewind process. Consequently, even after the player object 50 uses an item, the player can return the item possession state to the previous state, and for example, use the item at another timing.

In the exemplary embodiment, even if the player object 50 comes into contact with the item acquisition object 75 during the rewind process, an item is not given to the player object 50 in accordance with the contact. In another exemplary embodiment, an item may be able to be acquired during rewind.

The item possession state is returned by the rewind process, but the effect of an item is not returned by the rewind process. For example, in the state where the player object 50 possesses the item X3, if the player object 50 uses the item at the position P11, and the effect of the item (the invincible state) continues to a position P15, and even if the player object 50 returns to a position between the positions P15 to P11 by the rewind process, the player object 50 does not return to the invincible state. In this case, if the player object 50 returns to the position P11, the player object 50 returns to the state where the player object 50 possesses the item X3. In another exemplary embodiment, the effect of an item may also return by the rewind process.

There is also an item X5 that continues the state where the item X5 is being used for a predetermined period after the player object 50 starts using the item X5. If the player object 50 starts using such an item X5, and the rewind process is performed after a predetermined period, the possession state of the item X5 does not return unless the player object 50 returns to the point in time when the player object 50 starts using the item X5. That is, the player object 50 does not return to the state where the player object 50 is using the item X5 by the rewind process. In another exemplary embodiment, the player object 50 may return to the state where the player object 50 is using the item by the rewind process.

The rewind process on the item possession state may be configured to be able to be executed only during the second type of game, and may be configured to be unable to be executed during the first type of game. In this case, during the first type of game, the item possession state may not be stored as the history information.

The rewind process is configured to be able to be executed only in a particular game. Specifically, the rewind process is configured to be unable to be executed when the first type of game is being performed in the multiplay mode. In this case, the above history information may not be stored.

The rewind process except for the rewind process on the item possession state is configured to be able to be executed when the first type of game is being performed in the single play mode. That is, in the first type of game in the single play mode, based on the history information, the position, the orientation, the velocity, and the other states (e.g., the state regarding whether or not the wings are spread) of the player object 50 are returned, but the item possession state does not return even if the rewind process is performed. The rewind process including the rewind process on the item possession state is configured to be able to be executed when the second type of game is being performed.

If the rewind process can be executed when the first type of game is being performed in the multiplay mode, the balance of the racing game may collapse. For example, in a case where a first player object corresponding to a first player and a second player object corresponding to a second player perform the racing game, and if the rewind process on the first player object is performed, the second player object moves forward, whereas the first player object moves backward. As a result, the traveling directions of the first player object and the second player object are different from each other. Thus, the first player object and the second player object may collide with each other, or the difference between the degrees of progress of the first player object and the second player object in the racing game may become great, and the racing game may be less likely to come into effect. Thus, in the game according to the exemplary embodiment, the rewind process is configured to be unable to be executed when the first type of game is being performed in the multiplay mode.

If the rewind process on the item possession state can be executed when the first type of game is being performed in the multiplay mode or the single play mode, the player object using an item can rewind the item possession state, restore the item, and further use the item. As a result, the player object can use an item given in accordance with the ranking of the player object many times, and the balance of the racing game may collapse.

After the player object hits an item shot by an opponent object, the player object can also be returned to the state before the player object hits the item by the rewind process. Thus, the player object can avoid an item by the rewind function. As a result, the balance of the racing game may collapse.

Thus, in the exemplary embodiment, the rewind process is configured to be unable to be executed when the first type of game is being performed in the multiplay mode. The rewind process on the position, the orientation, and the velocity is configured to be able to be executed, but the rewind process on the item possession state is configured to be unable to be executed when the first type of game is being performed in the single play mode.

In contrast, in the second type of game, a race against a competitor is not performed, and the player can freely move the player object on the field, regardless of the time, the distance, or the place. By using the rewind function in such a second type of game, the player can return the player object to the state in the past after the player object passes through a particular place, cause the player object to run again on the particular place, and for example, can practice a place at which the player is not good many times. If there is a place or an object that the player overlooks while the player object is running on the field, the player returns the position of the player object by using the rewind function and thereby can view the place or the object that the player has overlooked. In the second type of game, for example, even if the player object 50 departs from a road, the player object 50 is not forcibly placed again in the road. However, if the player object 50 departs from a road, there is also a case where the user wishes to return the player object 50 onto the road. In such a case, the user can return the player object 50 to the position before the player object 50 departs from the road by the rewind function.

In the exemplary embodiment, the rewind process on the item possession state is configured to be unable to be executed when the first type of game is being performed in the single play mode. In another exemplary embodiment, the rewind process on the item possession state may be configured to be able to be executed when the first type of game is being performed in the single play mode.

In the exemplary embodiment, the rewind process on all the states including the item possession state is configured to be unable to be executed when the first type of game is being performed in the multiplay mode. In another exemplary embodiment, the rewind process is configured to be able to be executed also when the first type of game is performed in the multiplay mode. For example, the rewind process on all the states including the item possession state may be configured to be able to be executed when the first type of game is being performed in the multiplay mode. The rewind process on the states except for the item possession state may be configured to be able to be executed when the first type of game is being performed in the multiplay mode.

### (Condition Regarding End of Rewind Process)

As described above, while a rewind instruction is continuing to be given, the rewind process is performed. After the rewind process is started, and even if the rewind instruction ends, but if an end condition is not satisfied, the rewind process continues to be performed. In this case, when the end condition is satisfied, the rewind process is ended. Examples of the end condition for the rewind process are described below.

For example, the end condition may be a condition that the player object 50 is not in a particular state. When the player object 50 is in the particular state, the end condition is not satisfied. When the player object 50 ceases to be in the particular state, the end condition is satisfied. As the history information, information indicating whether or not the player object 50 is in the particular state is stored. For example, the particular state may be the state where the player object 50 is on a wall surface.

For example, if a predetermined operation input is performed, the player object 50 runs on a wall surface (a surface perpendicular to a plane in the horizontal direction of the virtual space) set on the field. When the player object 50 is on a wall surface, the end condition for the rewind process is not satisfied. For example, a case is assumed where the player object 50 moves from a position P1 to a position P2 on a ground, moves from the position P2 on the ground to a position P3 on a wall surface, moves from the position P3 to a position P4 on the wall surface, moves from the position P4 on the wall surface to a position P5 on the ground, and further moves from the position P5 to the position P6 on the ground. If a rewind instruction is started at the position P6, the player object 50 returns from P6 to P5 on the ground to P4 and P3 on the wall surface in reverse order by the rewind process. Here, when the player object 50 is on the wall surface (i.e., when the player object 50 is located between the positions P4 and P3), and even if the rewind instruction ends, the rewind process does not end at this point in time, and is continued. The rewind process continues to be performed until the player object 50 is not on the wall surface. Thus, even if the rewind instruction ends when the player object 50 is located on the wall surface, the rewind process is forcibly continued until the player object 50 returns to the position P2 on the ground. At the point in time when the player object 50 returns to the position P2 on the ground, the rewind process is ended. The rewind process may not end at the moment when the player object 50 returns from the wall surface onto the ground, and may end after the player object 50 returns from the wall surface onto the ground and when the player object 50 further returns by a predetermined distance.

The end condition may be a condition regarding the distance or the time rewound by the rewind process. For example, the end condition may not be satisfied until the player object 50 is rewound by a certain distance (or a certain time) or more by the rewind process. At the point in time when the player object 50 is rewound by the certain distance (or the certain time), the end condition may be satisfied, and the rewind process may end. For example, if the player can rewind the player object 50 by 2 m and then end the rewind instruction and end the rewind process, the player can cause the player object 50 to repeatedly perform the same action for a short time. For example, the player object 50 can repeatedly execute the use of an item and the rewind of the item possession state for a short time. Thus, the player object 50 can use the same item many times. As a result, the balance of the game may collapse. Thus, a configuration is employed in which the end condition is not satisfied until the player object 50 is rewound by the certain distance (or the certain time) or more by the rewind process.

If the player object 50 is in the state where the player object 50 in a particular scene where the player object 50 cannot return any further, the player object 50 may be controlled not to return to a scene before the particular scene. For example, in a case where the player object 50 is in the state where the player object 50 is in the particular scene, and if a rewind instruction is given, and the rewind process is performed in the particular scene, and even if the rewind instruction is continuing, the player object 50 may not return to a place before the place where the particular scene starts. For example, during the second type of game, the player object 50 may transition to the scene where the player object 50 performs a particular mission. As the history information, information indicating whether or not the player object 50 is performing the particular mission is stored. When the player object 50 is performing the particular mission, and if a rewind instruction is given, and even if the rewind instruction is continuing, the player object 50 may not return to a place before the place where the particular mission is started.

### (Details of Game Processing)

Next, the details of game processing performed by the game system 1 are described.

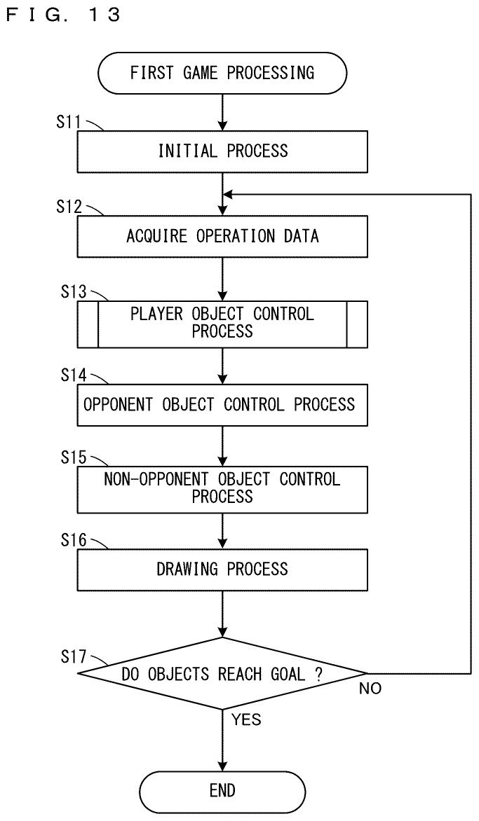

FIG. 11 is a diagram showing examples of various pieces of data stored in the game system 1. As shown in FIG. 11, a memory (e.g., the DRAM 27, a storage medium attached to the slot 29, or the flash memory 26) of the game system 1 stores a game program, player object data, history data, opponent object data, non-opponent object data, field data, and course data.

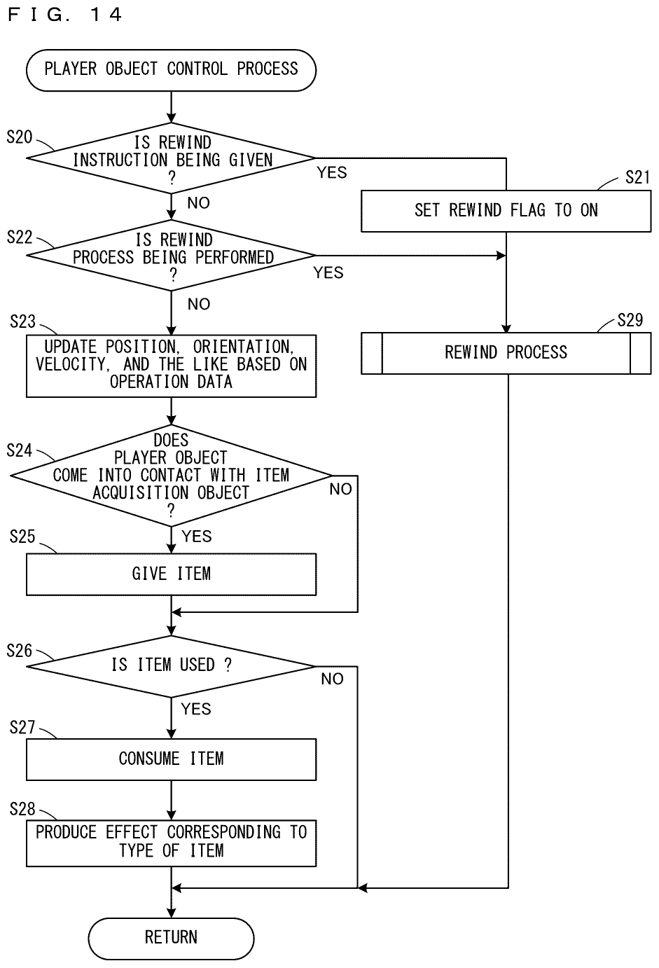

The game program is a program for executing processes related to the game according to the exemplary embodiment (processes shown in FIGS. 12 to 17 described below). The game program is stored in advance in the storage medium attached to the slot 29 or the flash memory 26 and is loaded into the DRAM 27 when the game is executed.

The player object data is data regarding the player object 50 controlled by the first player. The player object data includes object data indicating the shape and the external appearance of the player object 50, position/orientation data indicating the current position and orientation of the player object 50, and velocity data indicating the current velocity of the player object 50. The player object data also includes possessed item data indicating information regarding an item currently possessed by the player object 50, and other state data indicating other states (the invincible state, the state where the player object 50 is on a wall surface, the state where the player object 50 is performing a mission, the state where the player object 50 is spreading the wings, and the like) regarding the current player object 50.

The history data is data regarding the above history information. In the history data, position information, orientation information, velocity information, item possession information, and information regarding other states (e.g., the state where the player object 50 is on a wall surface, the state where the player object 50 is performing a mission, the state where the player object 50 is spreading the wings, and the like) regarding the player object 50 are stored in chronological order.

The opponent object data is data regarding the opponent object 51 and the like as the competitors of the player object 50 in the racing game. The opponent object data includes data regarding a plurality of opponent objects. The opponent object data includes data equivalent to the player object data. Specifically, the opponent object data includes position information, orientation information, velocity information, information regarding the item possession state, and information regarding other states regarding the opponent object 51.

The non-opponent object data is data regarding the non-opponent object 60 automatically controlled by the processor 21. The non-opponent object data includes position information, orientation information, velocity information, and the like regarding the non-opponent object 60.

The field data is data indicating the entirety of the field F and includes data indicating terrains. In the field, objects representing various terrains such as a road, a grassland, a sandy place, a wall, a building, and the like are set. The field data includes data indicating the types, the shapes, the external appearances, and the like of the terrains. The running velocity of the player object varies in accordance with the type of the terrain. For example, if the player object runs on a road, the player object can run at a first velocity. If the player object runs on a sandy place, the player object can run at a second velocity slower than the first velocity. The field data also includes data indicating a plurality of base areas.

The course data is data that defines a course where the first type of game is performed. For example, the course data includes data indicating the entirety of a route where the player object moves from a starting point to a goal point. The course data also includes data indicating the settings of an object that is not placed during the execution of the second type of game (e.g., an object that prevents branching or the like). In the exemplary embodiment, a plurality of courses are prepared in advance, and course data corresponding to each course is stored in advance. The course data may be stored in advance in the storage medium attached to the slot 29 or the flash memory 26, or may be acquired from the server via the Internet, or may be acquired from another main body apparatus 2.

Next, processes performed by the game system 1 are described. First, a description is given of a game selection process for allowing the player to select whether to execute the first type of game or execute the second type of game.

FIG. 12 is a flow chart showing an example of a/the game selection process.

In the exemplary embodiment, the description is given on the assumption that the processes of steps shown in FIGS. 12 to 17 are executed by the processor 21 of the main body apparatus 2 executing the game program using a memory (e.g., the DRAM 27). In another exemplary embodiment, however, some of the processes of the steps may be executed by a processor (e.g., a dedicated circuit or the like) different from the processor 21. In a case where the game system 1 can communicate with another information processing apparatus (e.g., a server), some of the processes of the steps may be executed by the other information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 12, the processor 21 performs a selection process for allowing the player to select the type of the game and the game mode (step S1). Here, the processor 21 displays a selection screen for allowing the player to select any of a plurality of types of games including the first type of game and the second type of game and receives an operation input from the player. In accordance with the operation input from the player, the processor 21 selects the type of the game to be executed. The processor 21 also displays a setting screen for allowing the player to select the game mode and receives an operation input from the player. In accordance with the operation input from the player, the processor 21 sets the game mode.

Next, the processor 21 determines whether or not the first type of game is selected in step S1 (step S2).

If the first type of game is selected (step S2: YES), the processor 21 starts first game processing regarding the first type of game (step S3). The first game processing is repeatedly performed until the first type of game ends. The details of the first game processing will be described below.

If the first type of game is not selected (step S2: NO), the processor 21 starts second game processing regarding the second type of game (step S4). The second game processing is repeatedly performed until the second type of game ends. The details of the second game processing will be described below.

If the first game processing or the second game processing ends, the processor 21 determines whether or not to end the game (step S5). Here, if an instruction to end the game is given by the player, the processor 21 ends the game. If, on the other hand, an instruction to end the game is not given by the player, the processor 21 executes the process of step S1 again.

### (First Game Processing)

Next, the first game processing is described. FIG. 13 is a flow chart showing an example of the first game processing regarding the first type of game. The first game processing is started if an instruction to start the first type of game is given by the player.

As shown in FIG. 13, first, the processor 21 performs an initial process (step S11). Here, the processor 21 sets any one of a plurality of courses based on a selection operation of the player and places the player object 50 and a plurality of opponent objects at a starting point of the set course. The processor 21 also places a plurality of non-opponent objects 60 on the course. If the initial process ends, the processor 21 starts the first type of game and executes the processes of next step S12 and subsequent steps.

If the first type of game is started, the processor 21 acquires operation data transmitted from the controllers 3 and 4 (step S12). From this point onward, the processor 21 repeatedly executes the processes of steps S12 to S17 at predetermined frame time intervals (e.g., 1/60-second intervals).

Next, the processor 21 executes a player object control process (step S13). Here, based on the operation data, the processor 21 updates the position, the orientation, the velocity, the item possession state, and the like of the player object 50 and causes the player object to perform a predetermined action. In accordance with the update of the position of the player object 50, the processor 21 also updates the position of the virtual camera. The details of the player object control process are described below.

### (Player Object Control Process)

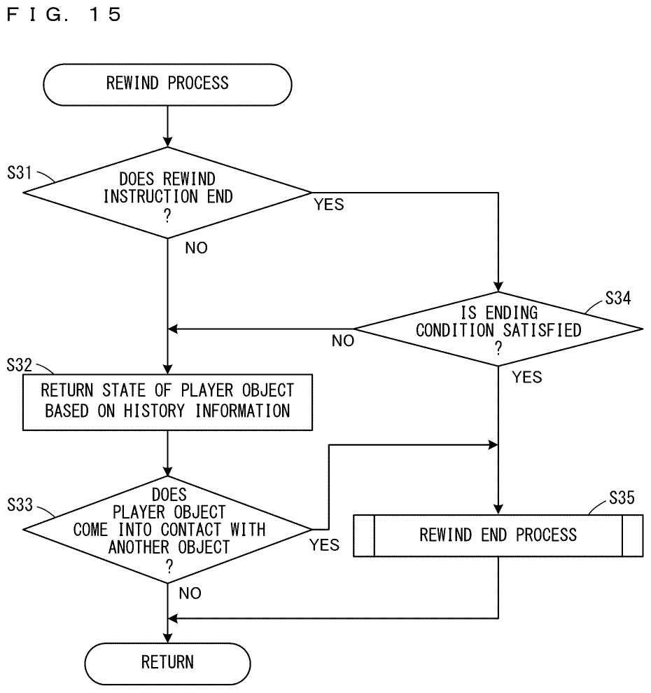

FIG. 14 is a flow chart showing an example of the player object control process in step S13.

As shown in FIG. 14, the processor 21 determines whether or not a rewind instruction is being given (e.g., the down button is being pressed) by the player (step S20). Specifically, the processor 21 determines whether or not the pressing of the down button is started or the down button is continuing to be pressed.

If the determination is YES in step S20, the processor 21 sets a rewind flag to ON (step S21). The rewind flag is a flag indicating whether or not the rewind process is being performed. The process of step S21 may be executed only if it is determined in step S20 that the pressing of the down button is started. The rewind flag is maintained to be ON until the rewind flag is set to OFF in a rewind end process described below.

If the determination is NO in step S20, the processor 21 determines whether or not the rewind process is being performed (step S22). Specifically, the processor 21 determines whether or not the rewind flag is ON.

If the rewind process is not being performed (step S22: NO), the processor 21 updates the position, the orientation, the velocity, and the like of the player object 50 based on the operation data (step S23). Here, the processor 21 updates the velocity of the player object 50 based on the current velocity and information indicating whether or not an accelerator operation is being performed. The processor 21 also updates the current position of the player object 50 in accordance with the velocity. If the player object 50 departs from the course, the processor 21 performs the process of placing the player object 50 on the course again. The processor 21 updates the orientation of the player object 50 based on the current orientation and information regarding a steering wheel operation. The processor 21 also determines whether or not the player object 50 collides with another object (a non-opponent object, an opponent object, an item shot by an opponent object, or the like). If the player object 50 collides with another object, the processor 21 decreases the velocity of the player object 50 or changes the position and the orientation of the player object 50. If an operation of causing the player object 50 to perform a predetermined action (e.g., a jump action or an action of spreading the wings) is performed, the processor 21 causes the player object 50 to perform the action. Every time the player object 50 moves forward by a predetermined distance (e.g., 2 m) in the virtual space, the processor 21 stores the state of the player object 50 as the history information in the memory. Specifically, the processor 21 stores information regarding the position, the orientation, the velocity, and the other states of the player object 50.

Next, based on the position of the player object 50, the processor 21 determines whether or not the player object 50 comes into contact with the item acquisition object 75 (step S24).

If the player object 50 comes into contact with the item acquisition object 75 (step S24: YES), the processor 21 gives an item to the player object 50 (step S25). Specifically, the processor 21 determines the type of an item to be given to the player object 50 based on the current ranking of the player object 50 and gives the determined item to the player object 50. The processor 21 stores information regarding the given item as possessed item data in the memory.

If the determination is NO in step S24, or if the process of step S25 is executed, based on the operation data, the processor 21 determines whether or not the player object 50 uses an item (step S26). Specifically, when the player object 50 is in the state where the player object 50 possesses an item, the processor 21 determines whether or not an instruction to use an item is given.

If the player object 50 uses an item (step S26: YES), the processor 21 consumes the item (step S27). Specifically, the processor 21 deletes information regarding the item used by the player object 50 from the possessed item data.

Next, the processor 21 produces an effect corresponding to the type of the used item (step S28). For example, if the item X1 is used, the processor 21 temporarily increases the velocity of the player object 50. If the item X2 is used, the processor 21 shoots the item X2 toward a preceding opponent object. The effect of the item is continued over a plurality of frames.

If the process of step S28 is executed, or if the determination is NO in step S26, the processor 21 ends the processing in FIG. 14.

On the other hand, if the process of step S21 is performed, or if the rewind process is being performed (step S22: YES), the processor 21 executes the rewind process (step S29). The details of the rewind process are described below.

### (Rewind Process)

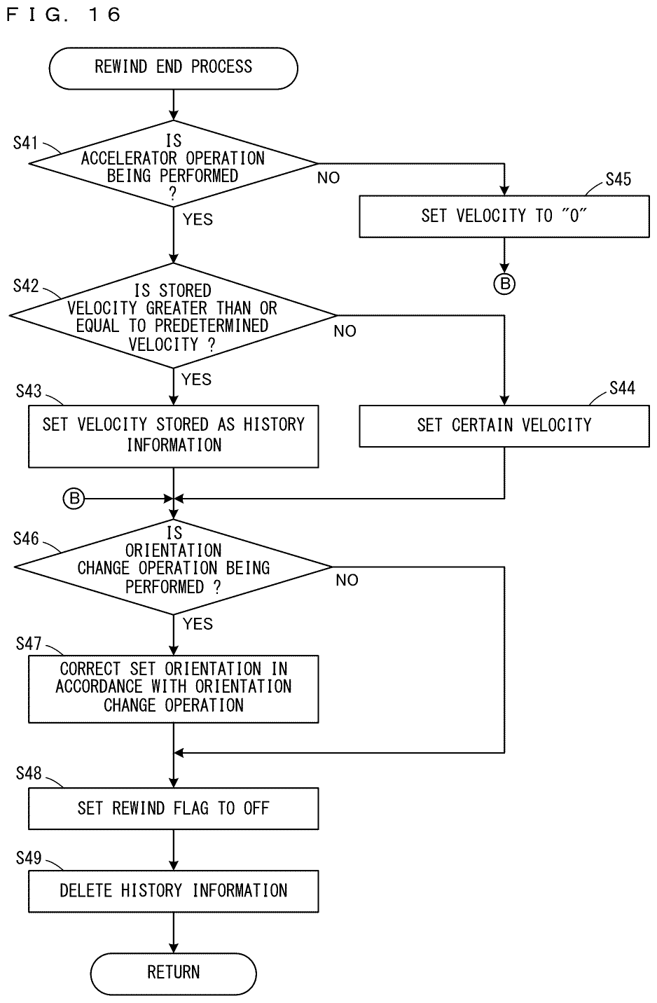

FIG. 15 is a flow chart showing an example of the rewind process in step S29.

As shown in FIG. 15, based on the operation data, the processor 21 determines whether or not the rewind instruction ends (step S31). Specifically, if the determination is YES in step S22, the processor 21 determines whether or not the rewind instruction already ends.

If the rewind instruction does not end (step S31: NO), the processor 21 returns the state of the player object 50 to the previous state based on the history information (step S32). Specifically, the processor 21 returns the position and the orientation of the player object 50 to the previous position and orientation. The processor 21 returns the other states (e.g., the state regarding whether or not the wings are spread) of the player object 50 to the previous states. In the first type of game, the item possession information regarding the player object 50 may not be stored as the history information. In step S32 in the first game processing, the item possession state of the player object 50 is not returned to the previous state. The process of step S32 may be performed in each frame, or for example, may be performed once every several frames.

Next, based on the position of the player object 50, the processor 21 determines whether or not the player object 50 comes into contact with another object (step S33). Another object is an opponent object or a non-opponent object 60.

If it is determined that the player object 50 does not come into contact with another object (step S33: NO), the processor 21 ends the processing shown in FIG. 15. If it is determined that the player object 50 comes into contact with another object (step S33: YES), next, the processor 21 executes the process of step S35.

If, on the other hand, the rewind instruction ends (step S31: YES), the processor 21 determines whether or not the end condition for the rewind process is satisfied (step S34). Here, in a case where the rewind instruction ends, it may be determined whether or not a plurality of end conditions are satisfied. For example, a first end condition for the rewind process may be the condition that the player object 50 returns by at least a certain distance (or a certain time) or more after the rewind process is started. For example, a second end condition for the rewind process may be the condition that the player object 50 is not located on a wall surface.

If it is determined that the end condition for the rewind process is not satisfied (step S34: NO), next, the processor 21 executes the process of step S32. That is, even if the rewind instruction ends, but if the end condition for the rewind process is not satisfied, the process of step S32 is executed.

If it is determined that the end condition for the rewind process is satisfied (step S34: YES), the processor 21 executes a rewind end process (step S35). The details of the rewind end process are described below.

### (Rewind End Process)

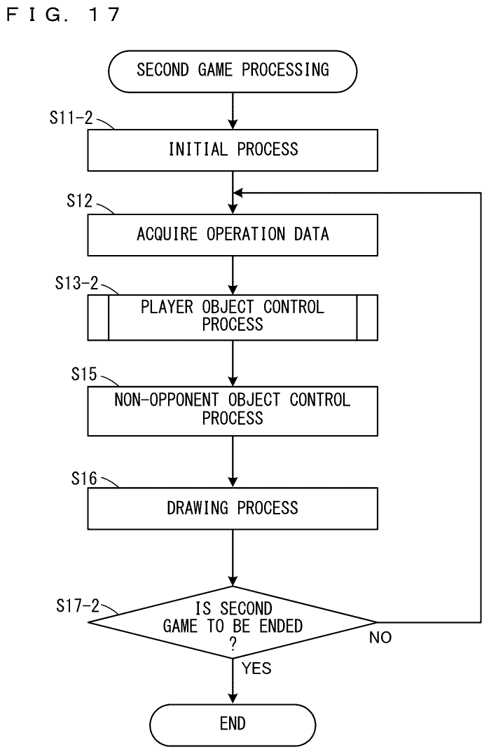

FIG. 16 is a flow chart showing an example of the rewind end process in step S35.

As shown in FIG. 16, based on the operation data, the processor 21 determines whether or not an accelerator operation (e.g., a pressing operation on the A-button) is being performed (step S41).

If the accelerator operation is being performed (step S41: YES), the processor 21 determines whether or not the velocity stored as the history information corresponding to the position of the player object 50 is greater than or equal to a predetermined velocity (step S42). Here, based on the history information, the processor 21 determines whether or not the velocity corresponding to the position of the player object 50 rewound in immediately preceding step S32 is greater than or equal to the predetermined velocity. For example, if the position of the player object 50 is returned to P12 in FIG. 7 in immediately preceding step S32, the processor 21 determines whether or not the velocity V12 corresponding to P12 is greater than or equal to the predetermined velocity.

If the determination is YES in step S42, the processor 21 sets the velocity stored as the history information corresponding to the position of the player object 50 as the velocity of the player object 50. For example, if the position of the player object 50 is returned to P12 in FIG. 7 in immediately preceding step S32, the processor 21 sets the velocity V12 corresponding to P12 as the velocity of the player object 50. That is, if the velocity of the player object 50 stored as the history information is greater than or equal to the predetermined velocity, the stored velocity is imparted as the initial velocity of the player object 50 at the point in time when the rewind process ends.

If the determination is NO in step S42, the processor 21 sets a certain velocity as the velocity of the player object 50 (step S44). That is, if the velocity of the player object 50 stored as the history information is slow, a certain velocity is imparted as the initial velocity of the player object 50 at the point in time when the rewind process ends. Consequently, it is possible to cause the player object 50 to move forward at some velocity from the moment when the rewind process ends and the game is resumed, and smoothly resume the game.

If, on the other hand, the accelerator operation is not being performed (step S41: NO), the processor 21 sets “O” as the velocity of the player object 50 (step S45). Consequently, it is possible to stop the player object 50 at the point in time when the rewind process ends and the game is resumed. Thus, it is easy for the player to visually confirm the periphery of the location where the rewind is performed.

If the process of step S43 is executed, or if the process of step S44 is executed, or if the process of step S45 is executed, based on the operation data, the processor 21 determines whether or not an orientation change operation is being performed (step S46).

If the orientation change operation is being performed (step S46: YES), in accordance with the orientation change operation, the processor 21 corrects the orientation set for the player object 50 in immediately preceding step S32 (step S47). That is, the orientation stored as the history information is corrected in accordance with the orientation change operation and set as the orientation of the player object 50. Consequently, the player can change the orientation of the player object 50 at the point in time when the rewind process ends and the game is resumed to a desired orientation.

If the process of step S47 is executed, or if the determination is NO in step S46, the processor 21 sets the rewind flag to OFF (step S48).

Next, the processor 21 discards the history information (step S49). Specifically, the processor 21 leaves the history information before the point in time when the rewind is performed, and discards the history information after the point in time when the rewind is performed. For example, in the example shown in FIG. 7, when the player object 50 is returned to the state of No. 3 and the rewind process is ended, the processor 21 leaves the history information regarding No. 1 and No. 2 and discards the history information regarding No. 3 to No. 5. After the game is resumed, the history information is stored in No. 3 and after that. The method for discarding the history information may be an appropriate method such as a method for deleting the history information from the memory, a method for setting the history information to be overwritten after the game is resumed, or the like.

If the process of step S49 is performed, the processor 21 ends the processing shown in FIG. 16 and returns the processing to FIG. 15.

As described above, if the accelerator operation is being performed at the point in time when the rewind process ends, the initial velocity of the player object 50 at the point in time when the rewind process ends is set based on the velocity information stored as the history information. If the accelerator operation is not being performed at the point in time when the rewind process ends, the game is resumed from the state where the player object 50 is stopped. If the orientation change operation is being performed at the point in time when the rewind process ends, the orientation stored as the history information is corrected in accordance with the orientation change operation, and the game is resumed with the orientation after the correction. If the orientation change operation is not being performed at the point in time when the rewind process ends, the game is resumed with the orientation stored as the history information (the orientation set in immediately preceding step S32).

Referring back to FIG. 15, if the process of step S35 is performed, the processor 21 ends the processing shown in FIG. 15 and returns the processing to FIG. 14.

Referring back to FIG. 14, if the process of step S29 is executed, the processor 21 ends the processing shown in FIG. 14 and returns the processing to FIG. 13.

Referring back to FIG. 13, after the process of step S13, the processor 21 executes an opponent object control process (step S14). Here, processing similar to the processing performed on the player object in the player object control process is performed on each opponent object. Specifically, the processor 21 updates the position, the orientation, the velocity, and the like of the opponent object, causes the opponent object to perform a predetermined action, gives an item to the opponent object, or causes the opponent object to use an item. For example, if the first type of game is performed in the online multiplay mode, the processor 21 receives information regarding the position, the orientation, and the velocity of the opponent object, item possession information, and information regarding an action regarding the opponent object, and the like from another main body apparatus 2 via the server on the Internet, and controls the opponent object based on the received information. If the first type of game is performed in the offline multiplay mode, the processor 21 controls the opponent object based on operation data from a controller for the opponent object wirelessly connected to the main body apparatus 2 or information regarding the opponent object received from another main body apparatus 2, If the first type of game is performed in the single play mode, the processor 21 controls the opponent object in accordance with a predetermined algorithm.

Next, the processor 21 executes a non-opponent object control process (step S15). Here, the processor 21 controls each non-opponent object 60 in accordance with a predetermined algorithm. Consequently, the position, the orientation, the velocity, and the like of the non-opponent object 60 are updated.

Next, the processor 21 performs a drawing process (step S16). In the drawing process, the processor 21 generates a game image based on the virtual camera corresponding to the player object 50 and outputs the generated game image to a display device (the display 12 or an external display device).

Next, the processor 21 determines whether or not the player object 50 and the opponent objects reach a goal (step S17). If the player object 50 and the opponent objects reach the goal, the processor 21 displays the result of the racing game and ends the processing shown in FIG. 13. If, on the other hand, the player object 50 and the opponent objects do not reach the goal (step S17: NO), the processor 21 returns the processing to step S12.

### (Second Game Processing)

Next, the second game processing is described. FIG. 17 is a flow chart showing an example of the second game processing regarding the second type of game. The second game processing is started if an instruction to start the second type of game is given by the player. In FIG. 17, processes similar to those in FIG. 13 are designated by the same numbers, and are not described.

As shown in FIG. 17, first, the processor 21 executes an initial process (step S11-2). In the initial process in step S11-2, a course is not set on the field, and the player object 50 is placed at a position on the field based on an operation input performed by the player. If the initial process ends, the second type of game is started.

After the process of step S12, the processor 21 performs a player object control process (step S13-2). The player object control process in step S13-2 is basically a process similar to that of step S13, but is different from that of step S13 in a part of the process. Specifically, in the player object control process in step S13-2, in the above step S23, in addition to the information regarding the position, the orientation, the velocity, and the other states of the player object 50, the item possession information is stored as the history information. In the player object control process in step S13-2, in the above step S23, even if the player object 50 departs from a road, the player object 50 is not placed again on the road. In the player object control process in step S13-2, in step S32 in the above rewind process, in addition to the position, the orientation, and the other states of the player object 50, the item possession state is returned to the previous state.

After the process of step S13-2, the processes of steps S15 and S16 are performed. In the second game processing, an opponent object control process is not performed.

After the process of step S16, the processor 21 determines whether or not to end the second game (step S17-2). For example, the processor 21 determines whether or not an instruction to end the second game is given by the player. If the second game is not to be ended, the processing of the processor 21 proceeds to step S12.

The processes shown in the above flow charts are merely illustrative, and the order and the contents of the processes, and the like may be appropriately changed.

As described above, in the exemplary embodiment, the position, the orientation, the velocity, the item possession information, and the like of the player object 50 are stored as the history information, and the rewind process for returning the player object 50 to the position in the past is performed based on the history information. Even while the rewind process is performed, movement control of another object is performed on the field. Consequently, it is possible to return only the player object 50 without returning the entirety of the scene of the game to the previous scene.

### (Variations)

While the exemplary embodiment has been described above, the exemplary embodiment is merely an example and may be modified as follows, for example.

For example, in the above exemplary embodiment, the position, the orientation, the velocity, the item possession state, and the like of the player object 50 are stored as the history information. In another exemplary embodiment, at least either one of the position and the velocity may be stored as the history information.

In the above exemplary embodiment, every time the player object 50 moves by a predetermined distance in the virtual space, the position and the velocity of the player object 50 are stored as the history information. In another exemplary embodiment, every time a predetermined time elapses, the position and the velocity of the player object 50 may be stored as the history information. That is, in accordance with the moving distance of the player object 50 or the lapse of time, the position and the velocity of the player object 50 may be stored as the history information.

In the above exemplary embodiment, a description has been given of the rewind process in a case where the player object 50 is caused to run on the field in the virtual space. The player object 50 may be able to fly in the air, and the position of the player object in the air may be returned by the above rewind process.

In the above exemplary embodiment, in the first type of game, at least a part of the rewind process is limited, and in the second type of game, the rewind process is performed without any limitation. In another exemplary embodiment, also in the first type of game, the rewind process may be performed without any limitation.

In the above exemplary embodiment, even if the rewind instruction ends, but when the player object 50 is in a particular state, the rewind process is continued. Even when the player object 50 is in the particular state, the rewind process may be ended in accordance with the end of the rewind instruction. For example, even when the player object 50 is on a wall surface during the rewind process, the rewind process may be ended in accordance with the end of the rewind instruction.

The above first type of game and second type of game may be the same type of game, or may be different types of games.

In a first scene, a racing game may be executed by performing movement control of a player object on a field in a virtual space based on an operation input. In a second scene, on the same field, movement control of the player object may be performed based on an operation input, movement control of another object may be performed, and in accordance with the moving distance of the player object or the lapse of time, history information including at least either of the velocity and the position of the player object in chronological order may be stored. Then, in accordance with a first instruction based on an operation input, the movement control of the other object may be continued, the movement control of the player object may be suspended, and based on the history information, rewind control for returning the player object to the position in the past in reverse order to the chronological order in which the history information is stored may be performed. Also in the above first scene, rewind control may be performed. The first scene and the second scene may be different scenes, or may be the same scene. For example, the first scene may be a scene in the above first type of game, and the second scene may be a scene in the above second type of game. The second scene may include the racing game in the first scene. For example, the first scene may be a scene in the multiplay mode of the above first type of game, and the second scene may be a scene in the single play mode of the above first type of game. The first scene and the second scene may be a scene in the single play mode of the above first type of game.

The above processing may be executed not only by the game system 1, but also by any other information processing apparatus or information processing system. The information processing system may include a plurality of apparatuses, and the plurality of apparatuses may be connected to each other via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute game processing comprising:
in a first scene,
executing a racing game by performing movement control of a player object based on an operation input on a field in a virtual space; and
in a second scene,
performing the movement control of the player object based on an operation input on the field,
performing movement control of another object on the field,
in accordance with a moving distance of the player object or a lapse of time, storing history information including at least either of a velocity and a position of the player object in chronological order, and
in accordance with a first instruction based on an operation input, continuing the movement control of the other object, suspending the movement control of the player object, and based on the history information, performing rewind control for returning the player object to a position in the past in reverse order to the chronological order in which the history information is stored.

2. The one or more non-transitory computer-readable media according to claim 1, wherein
the game processing further comprises
in the second scene, after the rewind control is performed, resuming the movement control of the player object, and resuming the storage of the history information in chronological order from continuation of the history information up to a point to which the rewind is performed.

3. The one or more non-transitory computer-readable media according to claim 2, wherein
the game processing further comprises
in the second scene, if the player object comes into contact with the other object when the rewind control is being performed, ending the rewind control.

4. The one or more non-transitory computer-readable media according to claim 1, wherein
the game processing further comprises
in the second scene, while the first instruction is continuing to be given, continuing the rewind control.

5. The one or more non-transitory computer-readable media according to claim 1, wherein
the history information includes the velocity of the player object, and
the game processing further comprises
after the rewind control is performed, based on the velocity stored at a point to which the rewind is performed in the history information, setting the velocity of the player object and resuming the movement control of the player object.

6. The one or more non-transitory computer-readable media according to claim 5, wherein
the game processing further comprises
after the rewind control is performed, and when the movement control of the player object is resumed,
if a forward movement instruction based on an operation input is being given, setting a moving velocity of the player object based on the velocity stored at a point to which the rewind is performed, and
if the forward movement instruction is not being given, stopping the player object.

7. The one or more non-transitory computer-readable media according to claim 1, wherein
the history information further includes an orientation of the player object, and
the game processing further comprises
in the second scene,
after the rewind control is performed, based on the orientation stored at a point to which the rewind is performed in the history information, setting the orientation of the player object, and
if a direction change instruction based on an operation input is further given, further changing the orientation of the player object and resuming the movement control of the player object.

8. The one or more non-transitory computer-readable media according to claim 1, wherein
the game processing further comprises:
in the first scene and the second scene,
if the player object satisfies a predetermined condition, causing the player object to transition to a state where the player object possesses an item for which a predetermined effect is set, and
if the player object is in the state where the player object possesses the item, in accordance with a second instruction based on an operation input, producing the effect set for the item and causing the player object to transition to a state where the player object does not possess the item; and
in the second scene,
further storing information regarding the item possessed by the player object in chronological order as the history information, and
in the rewind control, further, based on the history information, returning the item possessed by the player object to a state in the past in reverse order to the chronological order in which the history information is stored.

9. The one or more non-transitory computer-readable media according to claim 8, wherein
the game processing further comprises
in the second scene,
if the first instruction is given while the effect of the item is being produced, cancelling the effect of the item and performing the rewind control.

10. The one or more non-transitory computer-readable media according to claim 1, wherein
the second scene is a scene where the movement control of the player object is performed based on an operation input without performing a race on the field.

11. The one or more non-transitory computer-readable media according to claim 1, wherein
the game processing further comprises:
in the first scene, executing the racing game on a course set on the field, and if the player object departs from the course during the racing game, placing the player object in the course again and resuming the movement control of the player object; and
in the second scene, performing the movement control of the player object on the field where a course is not set.

12. The one or more non-transitory computer-readable media according to claim 1, wherein
the first scene is a scene where a racing game where an opponent object as an opponent in a race includes an opponent player object controlled in accordance with an operation of another player based on communication is performed, and
the second scene is a scene where a racing game where the opponent object does not include the opponent player object is performed.

13. The one or more non-transitory computer-readable media according to claim 1, wherein
the second scene includes a scene during a racing game in the first scene.

14. An information processing system comprising: one or more processors that execute game processing comprising:
in a first scene,
executing a racing game by performing movement control of a player object based on an operation input on a field in a virtual space; and
in a second scene,
performing the movement control of the player object based on an operation input on the field,
performing movement control of another object on the field,
in accordance with a moving distance of the player object or a lapse of time, storing history information including at least either of a velocity and a position of the player object in chronological order, and
in accordance with a first instruction based on an operation input, continuing the movement control of the other object, suspending the movement control of the player object, and based on the history information, performing rewind control for returning the player object to a position in the past in reverse order to the chronological order in which the history information is stored.

15. The information processing system according to claim 14, wherein
the game processing further comprises
in the second scene, after the rewind control is performed, resuming the movement control of the player object, and resuming the storage of the history information in chronological order from continuation of the history information up to a point to which the rewind is performed.

16. The information processing system according to claim 15, wherein
the game processing further comprises
in the second scene, if the player object comes into contact with the other object when the rewind control is being performed, ending the rewind control.

17. The information processing system according to claim 14, wherein
the game processing further comprises
in the second scene, while the first instruction is continuing to be given, continuing the rewind control.

18. The information processing system according to claim 14, wherein
the history information includes the velocity of the player object, and
the game processing further comprises
after the rewind control is performed, based on the velocity stored at a point to which the rewind is performed in the history information, setting the velocity of the player object and resuming the movement control of the player object.

19. The information processing system according to claim 18, wherein
the game processing further comprises
after the rewind control is performed, and when the movement control of the player object is resumed,
if a forward movement instruction based on an operation input is being given, setting a moving velocity of the player object based on the velocity stored at a point to which the rewind is performed, and
if the forward movement instruction is not being given, stopping the player object.

20. The information processing system according to claim 14, wherein
the history information further includes an orientation of the player object, and
the game processing further comprises
in the second scene,
after the rewind control is performed, based on the orientation stored at a point to which the rewind is performed in the history information, setting the orientation of the player object, and
if a direction change instruction based on an operation input is further given, further changing the orientation of the player object and resuming the movement control of the player object.

21. The information processing system according to claim 14, wherein
the game processing further comprises:
in the first scene and the second scene,
if the player object satisfies a predetermined condition, causing the player object to transition to a state where the player object possesses an item for which a predetermined effect is set, and
if the player object is in the state where the player object possesses the item, in accordance with a second instruction based on an operation input, producing the effect set for the item and causing the player object to transition to a state where the player object does not possess the item; and
in the second scene,
further storing information regarding the item possessed by the player object in chronological order as the history information, and
in the rewind control, further, based on the history information, returning the item possessed by the player object to a state in the past in reverse order to the chronological order in which the history information is stored.

22. The information processing system according to claim 21, wherein
the game processing further comprises
in the second scene,
if the first instruction is given while the effect of the item is being produced, cancelling the effect of the item and performing the rewind control.

23. The information processing system according to claim 14, wherein
the second scene is a scene where the movement control of the player object is performed based on an operation input without performing a race on the field.

24. The information processing system according to claim 14, wherein
the game processing further comprises:
in the first scene, executing the racing game on a course set on the field, and if the player object departs from the course during the racing game, placing the player object in the course again and resuming the movement control of the player object; and
in the second scene, performing the movement control of the player object on the field where a course is not set.

25. The information processing system according to claim 14, wherein
the first scene is a scene where a racing game where an opponent object as an opponent in a race includes an opponent player object controlled in accordance with an operation of another player based on communication is performed, and
the second scene is a scene where a racing game where the opponent object does not include the opponent player object is performed.

26. The information processing system according to claim 14, wherein
the second scene includes a scene during a racing game in the first scene.

27. An information processing method performed by an information processing system, the information processing method comprising:
in a first scene,
executing a racing game by performing movement control of a player object based on an operation input on a field in a virtual space; and
in a second scene,
performing the movement control of the player object based on an operation input on the field,
performing movement control of another object on the field,
in accordance with a moving distance of the player object or a lapse of time, storing history information including at least either of a velocity and a position of the player object in chronological order, and
in accordance with a first instruction based on an operation input, continuing the movement control of the other object, suspending the movement control of the player object, and based on the history information, performing rewind control for returning the player object to a position in the past in reverse order to the chronological order in which the history information is stored.

28. The information processing method according to claim 27, further comprising
in the second scene, after the rewind control is performed, resuming the movement control of the player object, and resuming the storage of the history information in chronological order from continuation of the history information up to a point to which the rewind is performed.

29. The information processing method according to claim 28, further comprising
in the second scene, if the player object comes into contact with the other object when the rewind control is being performed, ending the rewind control.

30. The information processing method according to claim 27, further comprising
in the second scene, while the first instruction is continuing to be given, continuing the rewind control.

31. The information processing method according to claim 27, wherein
the history information includes the velocity of the player object, and
the information processing method further comprises
after the rewind control is performed, based on the velocity stored at a point to which the rewind is performed in the history information, setting the velocity of the player object and resuming the movement control of the player object.

32. The information processing method according to claim 31, further comprising
after the rewind control is performed, and when the movement control of the player object is resumed,
if a forward movement instruction based on an operation input is being given, setting a moving velocity of the player object based on the velocity stored at a point to which the rewind is performed, and
if the forward movement instruction is not being given, stopping the player object.

33. The information processing method according to claim 27, wherein
the history information further includes an orientation of the player object, and
the information processing method further comprises
in the second scene,
after the rewind control is performed, based on the orientation stored at a point to which the rewind is performed in the history information, setting the orientation of the player object, and
if a direction change instruction based on an operation input is further given, further changing the orientation of the player object and resuming the movement control of the player object.

34. The information processing method according to claim 27, further comprising:
in the first scene and the second scene,
if the player object satisfies a predetermined condition, causing the player object to transition to a state where the player object possesses an item for which a predetermined effect is set, and
if the player object is in the state where the player object possesses the item, in accordance with a second instruction based on an operation input, producing the effect set for the item and causing the player object to transition to a state where the player object does not possess the item; and
in the second scene,
further storing information regarding the item possessed by the player object in chronological order as the history information, and
in the rewind control, further, based on the history information, returning the item possessed by the player object to a state in the past in reverse order to the chronological order in which the history information is stored.

35. The information processing method according to claim 34, further comprising
in the second scene,
if the first instruction is given while the effect of the item is being produced, cancelling the effect of the item and performing the rewind control.

36. The information processing method according to claim 27, wherein
the second scene is a scene where the movement control of the player object is performed based on an operation input without performing a race on the field.

37. The information processing method according to claim 27, further comprising:
in the first scene, executing the racing game on a course set on the field, and if the player object departs from the course during the racing game, placing the player object in the course again and resuming the movement control of the player object; and
in the second scene, performing the movement control of the player object on the field where a course is not set.

38. The information processing method according to claim 27, wherein
the first scene is a scene where a racing game where an opponent object as an opponent in a race includes an opponent player object controlled in accordance with an operation of another player based on communication is performed, and
the second scene is a scene where a racing game where the opponent object does not include the opponent player object is performed.

39. The information processing method according to claim 27, wherein
the second scene includes a scene during a racing game in the first scene.
